(19) United States
(12) Patent Application Publication
(10) Pub. No.: US 2025/0074542 A1
(43) Pub. Date: Mar. 6, 2025

(54) MOTORIZED BICYCLE DRIVE SYSTEM

(71) Applicant: Bimotal Inc., Berkeley, CA (US)

(72) Inventors: Tobias Sebastian Ricco, San Francisco, CA (US); Andrès Pastor Mallagray, Berkeley, CA (US); Matt Rounds, Albany, CA (US); Neil Flock, El Cerrito, CA (US); Swadhin Gite, Berlin (DE); Ryan Sellers, Oakland, CA (US); Adam Ellison, Claymont, DE (US)

(21) Appl. No.: 18/820,853

(22) Filed: Aug. 30, 2024

Related U.S. Application Data
(60) Provisional application No. 63/580,135, filed on Sep. 1, 2023.
(60) Provisional application No. 63/580,138, filed on Sep. 1, 2023.
(60) Provisional application No. 63/580,140, filed on Sep. 1, 2023.
(60) Provisional application No. 63/580,142, filed on Sep. 1, 2023.

(51) Int. Cl. B62M 6/55; B62M 6/50; B62M 9/04; B62M 11/02

(52) U.S. Cl. CPC B62M 6/55; B62M 6/50; B62M 9/04; B62M 11/02

(57) ABSTRACT

A motorized bicycle system includes an electric drive system generating a first drive torque through an electric drive motor and a mid-drive gear box system. A pedal drive system produces a second drive torque via a spindle system. A clutch system regulates the first and second drive torques to create a third output torque for driving a wheel of the bicycle. The mid-drive gear box system features a gear reduction stage with concentric gears around the pedal drive system's spindle body. Additionally, a parallel axis idler gearset includes two idler gears transmitting torque between gears of the gear reduction stage. This innovative system efficiently combines electric and pedal power for enhanced bicycle performance.

### RELATED APPLICATIONS

The is application claims benefit of and priority to U.S. Provisional Patent Application No. 63/580,135 filed on Sep. 1, 2023 and titled “MID-DRIVE SYSTEM (MDS),” U.S. Provisional Patent Application No.63/580, 138 filed on Sep. 1, 2023 and titled “MID-DRIVE PINION CONCENTRIC TO SPINDLE (PCS),” U.S. Provisional Patent Application No. 63/580,140 filed on Sep. 1, 2023 and titled “MID-DRIVE WITH PARALLEL AXIS IDLER GEARS (PAIG),” and U.S. Provisional Patent Application No. 63/580,142 filed on Sep. 1, 2023 and titled “MID-DRIVE PEDAL ASSIST FLEX CIRCUIT (PAS-FC),” the entireties of each are hereby incorporated by reference.

### FIELD

Embodiments relate generally to powertrains and more specifically to powertrains for vehicles such as electric bicycles (e-bikes).

### BACKGROUND

An electric bicycle, commonly known as an “e-bike,” is a type of bicycle that integrates an electric motor to assist with propulsion. The inclusion of a motor and a battery distinguishes them from traditional bicycles, offering a versatile option for commuting, recreation, and fitness. The motor can, for example, assist a rider's pedaling effort, which can be particularly helpful when tackling hills, carrying heavy loads, or simply making cycling easier over longer distances. E-bikes have seen a rise in popularity due to their ability to blend the advantages of traditional cycling with the added benefit of assisted electric propulsion.

E-bikes are available in various styles, including mountain bikes, commuter bikes, cargo bikes, road bikes, and tricycles, among others. They typically fall into different categories based on how the motor provides assistance. For example, in a pedal-assist (Pedelec) e-bike, the motor provides assistance when the rider is pedaling, and the level of assistance can often be adjusted, allowing the rider to choose how much help they want from the motor. In a throttle-based e-bike, the motor can be engaged by using a throttle, similar to a motorcycle or scooter, providing propulsion without the need to pedal.

### SUMMARY

Existing motorized bicycle systems, including e-bikes, typically utilize either electric drive systems or pedal drive systems to provide propulsion. Electric drive systems often consist of an electric drive motor that outputs a motor torque to drive the bicycle. These systems may include gear reduction mechanisms to adjust the torque output to the desired level for efficient operation. However, the integration of electric drive systems with human-powered pedal drive systems in motorized bicycles has presented challenges in terms of coordinating the torque output from both systems to achieve optimal performance and efficiency. Systems struggle to effectively combine the torque output from the electric drive motor and the pedal input torque to generate a unified output torque for propulsion.

Pedal drive systems in motorized bicycles traditionally rely on a spindle system to receive the pedal input force, converted to a torque by the lever arm of the crank arms which is referred to as “pedal torque”, and convert it into a drive torque for propulsion. These systems may incorporate gear mechanisms to adjust the torque output based on the pedaling force applied by the rider. However, the coordination of the pedal drive system with an electric drive system in a motorized bicycle presents complexities in terms of synchronizing the torque outputs from both systems to ensure smooth and efficient operation. Previous approaches have attempted to address this challenge by incorporating complex clutch systems or gear arrangements to regulate the torque distribution between the electric drive system and the pedal drive system.

In the field of motorized bicycles, efforts have been made to develop gear box systems that can efficiently transmit and adjust torque from the electric drive motor and the pedal input torque to generate a combined output torque for propulsion. These gear box systems may include concentric gears and idler gearsets to facilitate the transmission of torque between different components of the system. However, existing gear box systems have faced limitations in terms of at least size and efficiency. For example, some gear systems require a large gearing footprint to achieve suitable gearing reductions. In the case of more compact designs (e.g., harmonic pin ring and strain-wave differential type gearboxes having elements disposed about a spindle), they often suffer from lower efficiency. These result in suboptimal designs and performance.

E-bike propulsion systems typically employ a drive unit that converts electrical energy into mechanical energy to assist the rider. An e-bike mid-drive unit typically includes a sophisticated battery powered electric motor system positioned near the center of the bike's frame, typically at the bottom bracket where the pedals and crank arms are located. Such a placement may provide an improved weight distribution and a lower center of gravity, which can enhance the bike's balance and handling. Unlike hub motors, which are typically located in the wheels, mid-drive units often have an output that directly engages with the bike's drivetrain, allowing the motor to drive a chain or belt of the bike. Such an integration may, for example, enable the motor to take advantage of the bike's gears, providing greater torque and efficiency, especially when climbing hills or navigating challenging terrain. Additionally, the central placement of the motor helps maintain the natural feel of pedaling, contributing to a smoother and more intuitive riding experience. Mid-drive units typically include gear reduction systems to amplify motor provided torque. As a result, mid-drive systems are known for their performance in terms of range, power delivery, and overall riding experience, making them the preferred choice for e-bikes used in demanding applications like mountain biking, cargo transport, and steep inclines.

While mid-drive units offer numerous advantages, they also come with some drawbacks that can affect the overall riding experience. One concern is their size and complexity. Mid-drive units are typically relatively large and heavy, which can make them more challenging to physically integrate into a bike. Their central placement, while beneficial for balance, can also lead to a more cluttered appearance and may interfere with certain frame design considerations, such as suspension and battery placement, especially in the case of bulkier mid-drive units. Another drawback is noise generated by mid-drive units. Mid-drive systems often produce more mechanical noise due to the motor's gearing. This noise can be particularly noticeable when shifting gears or under heavy load, which can detract from the overall riding experience, especially in quiet environments.

Provided are embodiments for a relatively compact, powerful, efficient, and quiet e-bike mid-drive system. In some embodiments, a mid-drive system incorporates concentric gearing that can facilitate a relatively compact, efficient, and powerful mid-drive unit. For example, in some embodiments, a mid-drive gear box system employs a gear reduction stage including one or more gears disposed concentric to a pedal spindle. This may facilitate the gear reduction stage being compact and encompassed in a relatively small volume. For example, the compact components may enable the mid-drive to be fit within a relatively small housing, taking up less space in the e-bike system. In some embodiments, a mid-drive system incorporates parallel axis idler gearset. This may facilitate a relatively compact, quiet, efficient, and powerful mid-drive unit by, for example, decoupling the motor diameter size from the first stage center-to-center gear mesh distance. For example, a mid-drive gear box system may employ a gear reduction stage that includes a parallel axis idler gearset having first and second idler gears that both engage an input gear (e.g., a motor pinion gear) and an output gear (e.g., a later stage driven gear). Such idler gears can work in unison as a constrained gear system, to transfer torque from the input gear to the output gear. In some instances, the idler gears are formed of a polymer (e.g., a plastic material). This may enable a relatively large amount of torque to be transmitted quietly by way of two relatively small, lightweight gears. Additionally, this may enable use of different motor sizes, such as use of a larger motor diameter by moving the motor center further from the spindle center, which can facilitate improvements to torque density and efficiency of the overall system. In some embodiments, the idler gears are disposed about posts or similar support members that are also used to support other components of the gear reduction stage, such as other gears. For example, posts extending from a faceplate of gearbox housing and through the idler gears may secure positions of the idler gears and also support a bearing and associated gear located away from the faceplate, toward a middle of the gearbox housing. Such an arrangement may contribute to a relatively compact gear reduction stage and mid-drive unit. In some embodiments, a spindle system employs a flex circuit system to route signals along a spindle, clear of concentric gears disposed about the spindle. For example, a flex circuit may be routed along a length of the spindle, through the interior of rotating concentric gears. This may facilitate maintaining an ability to transmit signals across the mid-drive while using gears concentric to the spindle. For example, where the gear reduction stage employs gears disposed concentric to a pedal spindle, the pedal spindle may include openings, recesses, or the like, that facilitate passage of a flex circuit (e.g., a flexible cable) along the length of pedal spindle. In such an embodiment, the flex circuit may be employed to transmit signals from one side of the gear reduction stage to the other, along a path in or adjacent to the pedal spindle and free of interaction with concentric gears rotating about the spindle. Such a configuration may facilitate compact arrangement of the spindle and gears, such as two or three gears and the sensing system arranged concentric to the spindle, further contributing to a relatively compact gear reduction stage and mid-drive unit.

Certain embodiments relate to a mid-drive pinion concentric to spindle (PCS), which may provide a relatively high gear-reduction-ratio gearbox in a relatively small/compact space, while also accommodating human input. Such embodiments may provide higher torque density, reduced drive unit volume, and provide greater flexibility in e-bike design, such as the ability to locate the battery in front of the drive unit (e.g., due to the unit's shorter length), the ability to better mount and position suspension components in locations ideal for kinematics, and the ability to configure the drive unit for various torque applications (e.g., for low-torque and high-torque applications achieved via software without the need for mechanical alterations). Certain embodiments relate to a mid-drive with parallel axis idler gears (PAIG) system, which may provide a relatively quiet, torque-dense drive unit (e.g., by providing a flexible distance between the motor axis and spindle axis, potentially unconstrained by a single gear-mesh dimension). In some instances, use of non-metallic (e.g., plastic) gears can help to decrease noise generation. Further, employing multiple (e.g., two) plastic gears may help to enhance torque transmission, and facilitate arrangement of multiple gears concentric to the spindle. Certain embodiments relate to a mid-drive pedal assist flex circuit (PAS-FC), which may provide a relatively small package size. Further, such embodiments may enhance manufacturability and provide adequate space to facilitate placement of multiple (e.g., two, three, or more) gears concentric to the spindle. Accordingly, described embodiment can provide ways to address existing challenges of mid-drive gearbox topologies, and enhance efficiency, functionality, and user experience of e-bikes and other human/motor hybrid-powered vehicles.

Although certain embodiments are described in the context of an e-bike type vehicle system for the purpose of illustration, embodiments may be employed in any suitable context. For example, the described mid-drive unit aspects may be employed in the context of other powered vehicles, such as motorcycles. Also, although certain embodiments are described in the context of a given type of drivetrain system, such as a chain or belt based wheel drive system, for the purpose of illustration, embodiments may be employed in any suitable context. For example, the described mid-drive unit aspects may be employed in a direct drive system or drive system using chains, belts, or other intermediate components.

### BRIEF DESCRIPTION OF THE DRAWINGS

FIGS. 1A and 1B are diagrams that illustrate a vehicle system in accordance with one or more embodiments.

FIGS. 2A and 2B are diagrams that illustrate a vehicle drive system in accordance with one or more embodiments.

FIGS. 3A-3S are diagrams that illustrate various views of a vehicle drive system in accordance with one or more embodiments.

FIGS. 4A-4B are diagrams that illustrate various views of a torque sensing system incorporating a flex circuit in accordance with one or more embodiments.

FIGS. 5A and 5B are diagrams that illustrate various views of a clutch system in accordance with one or more embodiments.

While this disclosure is susceptible to various modifications and alternative forms, specific example embodiments are shown and described. The drawings may not be to scale. It should be understood that the drawings and the detailed description are not intended to limit the disclosure to the particular form disclosed, but are intended to disclose modifications, equivalents, and alternatives falling within the spirit and scope of the present disclosure as defined by the claims.

### DETAILED DESCRIPTION

Described are embodiments that provide a relatively compact, powerful, efficient, and quiet e-bike mid-drive system. In some embodiments, a mid-drive system incorporates concentric gearing that can facilitate a relatively compact, efficient, and powerful mid-drive unit. For example, in some embodiments, a mid-drive gear box system employs a gear reduction stage including one or more gears disposed concentric to a pedal spindle. This may facilitate the gear reduction stage being compact and encompassed in a relatively small volume. For example, the compact components may enable the mid-drive to be fit within a relatively small housing, taking up less space in the e-bike system. In some embodiments, a mid-drive system incorporates parallel axis idler gearset. This may facilitate a relatively compact, quiet, efficient, and powerful mid-drive unit by, for example, decoupling the motor diameter size from the first stage center-to-center gear mesh distance. For example, a mid-drive gear box system may employ a gear reduction stage that includes a parallel axis idler gearset having first and second idler gears that both engage an input gear (e.g., a motor pinion gear) and an output gear (e.g., a later stage driven gear). Such idler gears can work in unison as a constrained gear system, to transfer torque from the input gear to the output gear. In some instances, the idler gears are formed of a polymer (e.g., a plastic material). This may enable a relatively large amount of torque to be transmitted quietly by way of two relatively small, lightweight gears. Additionally, this may enable use of different motor sizes, such as use of a larger motor diameter by moving the motor center further from the spindle center, which can facilitate improvements to torque density and efficiency of the overall system. In some embodiments, the idler gears are disposed about posts or similar support members that are also used to support other components of the gear reduction stage, such as other gears. For example, posts extending from a faceplate of gearbox housing and through the idler gears may secure positions of the idler gears and also support a bearing and associated gear located away from the faceplate, toward a middle of the gearbox housing. Such an arrangement may contribute to a relatively compact gear reduction stage and mid-drive unit. In some embodiments, a spindle system employs a flex circuit system to route signals along a spindle, clear of concentric gears disposed about the spindle. For example, a flex circuit may be routed along a length of the spindle, through the interior of rotating concentric gears. This may facilitate maintaining an ability to transmit signals across the mid-drive while using gears concentric to the spindle. For example, where the gear reduction stage employs gears disposed concentric to a pedal spindle, the pedal spindle may include openings, recesses, or the like, that facilitate passage of a flex circuit (e.g., a flexible cable) along the length of pedal spindle. In such an embodiment, the flex circuit may be employed to transmit signals from one side of the gear reduction stage to the other, along a path in or adjacent to the pedal spindle and free of interaction with concentric gears rotating about the spindle. Such a configuration may facilitate compact arrangement of the spindle and gears, such as two or three gears and the sensing system arranged concentric to the spindle, further contributing to a relatively compact gear reduction stage and mid-drive unit.

Certain embodiments relate to a mid-drive pinion concentric to spindle (PCS), which may provide a relatively high gear-reduction-ratio gearbox in a relatively small/compact space, while also accommodating human input. Such embodiments may provide higher torque density, reduced drive unit volume, and provide greater flexibility in e-bike design, such as the ability to locate the battery in front of the drive unit (e.g., due to the unit's shorter length), the ability to better mount and position suspension components in locations ideal for kinematics, and the ability to configure the drive unit for various torque applications (e.g., for low-torque and high-torque applications achieved via software without the need for mechanical alterations). Certain embodiments relate to a mid-drive with parallel axis idler gears (PAIG) system, which may provide a relatively quiet, torque-dense drive unit (e.g., by providing a flexible distance between the motor axis and spindle axis, potentially unconstrained by a single gear-mesh dimension). In some instances, use of non-metallic (e.g., plastic) gears can help to decrease noise generation. Further, employing multiple (e.g., two) plastic gears may help to enhance torque transmission, and facilitate arrangement of multiple gears concentric to the spindle. Certain embodiments relate to a mid-drive pedal assist flex circuit (PAS-FC), which may provide a relatively small package size. Further, such embodiments may enhance manufacturability and provide adequate space to facilitate placement of multiple (e.g., two, three, or more) gears concentric to the spindle. Accordingly, described embodiment can provide ways to address existing challenges of mid-drive gearbox topologies, and enhance efficiency, functionality, and user experience of e-bikes and other human/motor hybrid-powered vehicles.

Although certain embodiments are described in the context of an e-bike type vehicle system for the purpose of illustration, embodiments may be employed in any suitable context. For example, the described mid-drive unit aspects may be employed in the context of other powered vehicles, such as motorcycles. Also, although certain embodiments are described in the context of a given type of drivetrain system, such as a chain or belt based wheel drive system, for the purpose of illustration, embodiments may be employed in any suitable context. For example, the described mid-drive unit aspects may be employed in a direct drive system or drive system using chains, belts, or other intermediate components.

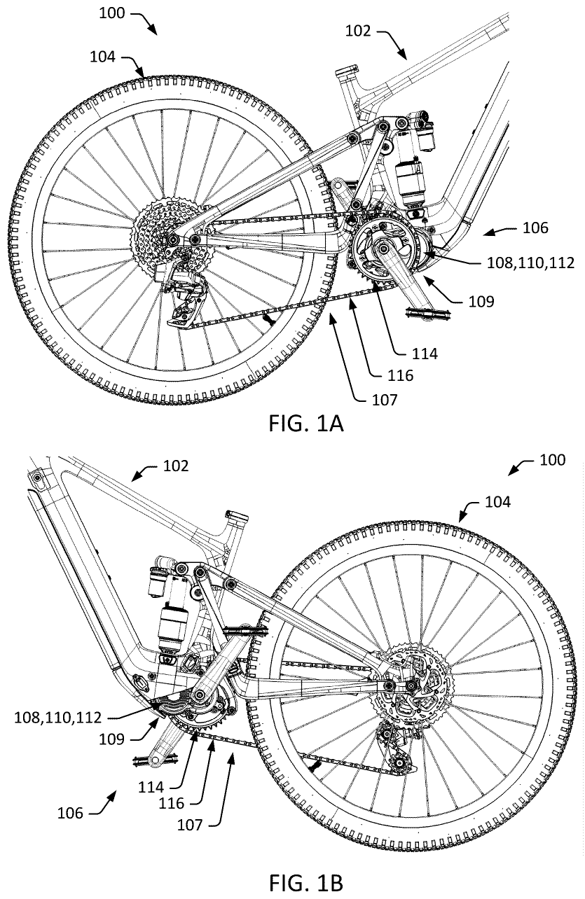

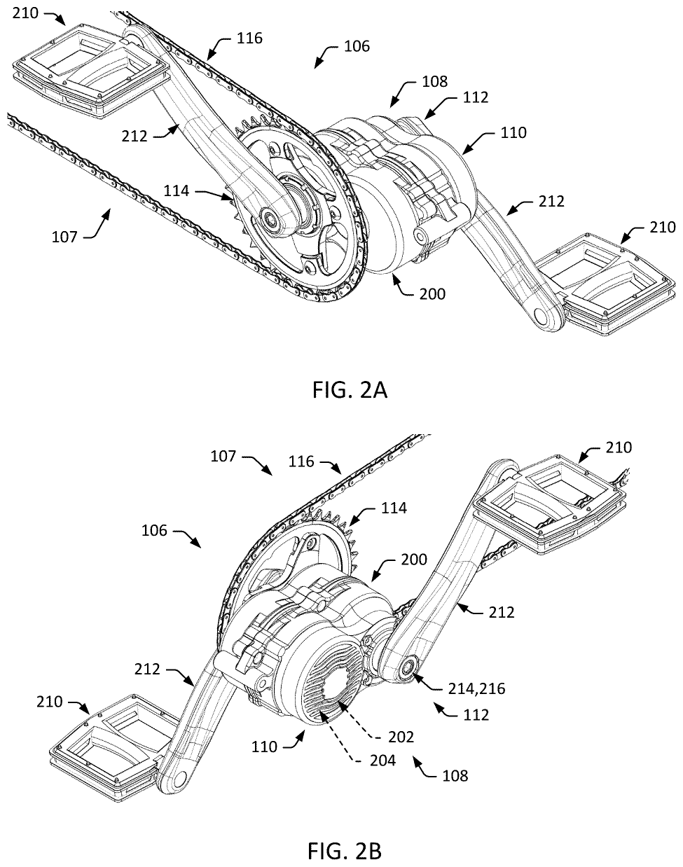

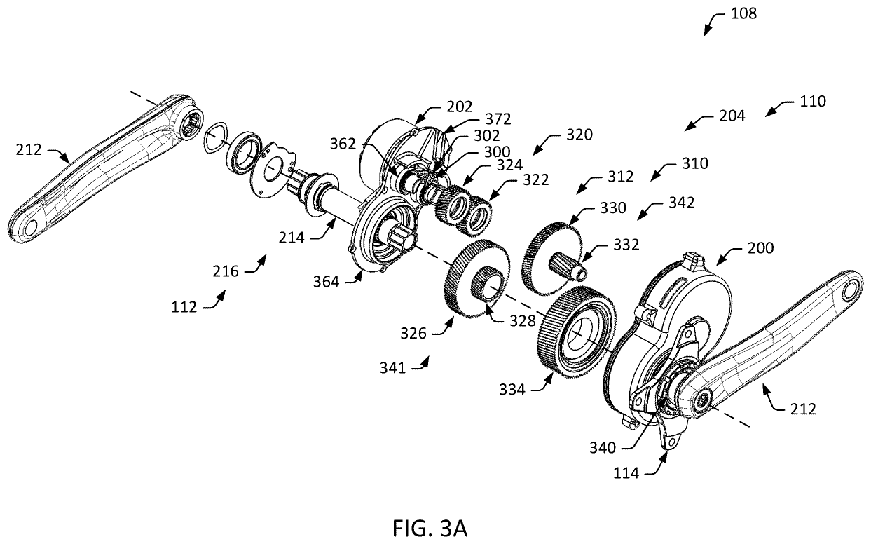

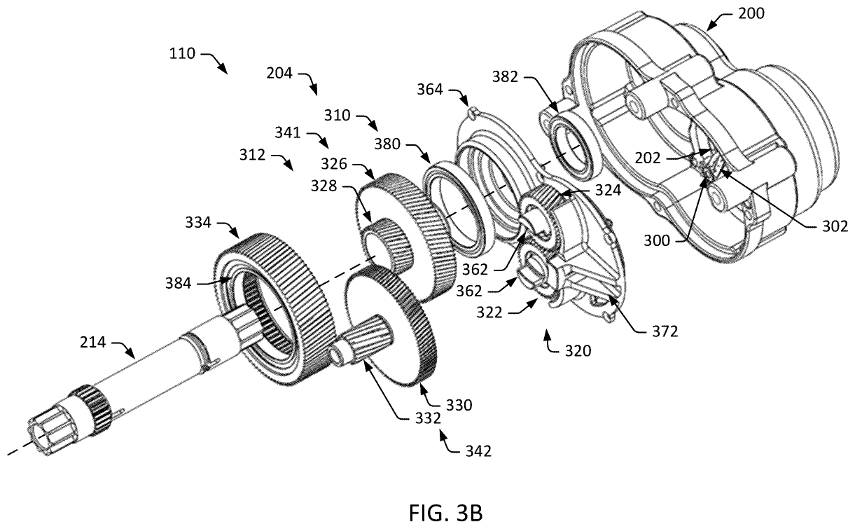

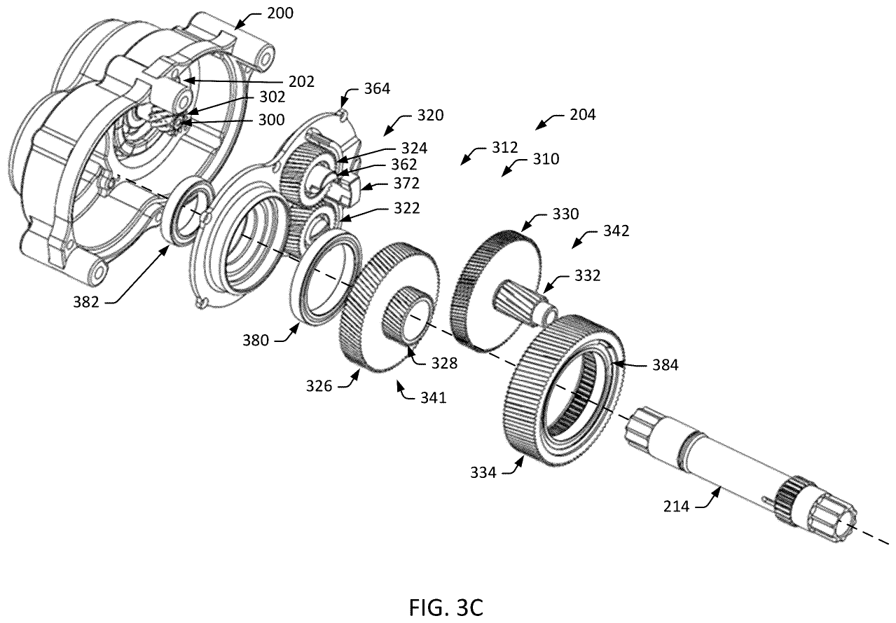

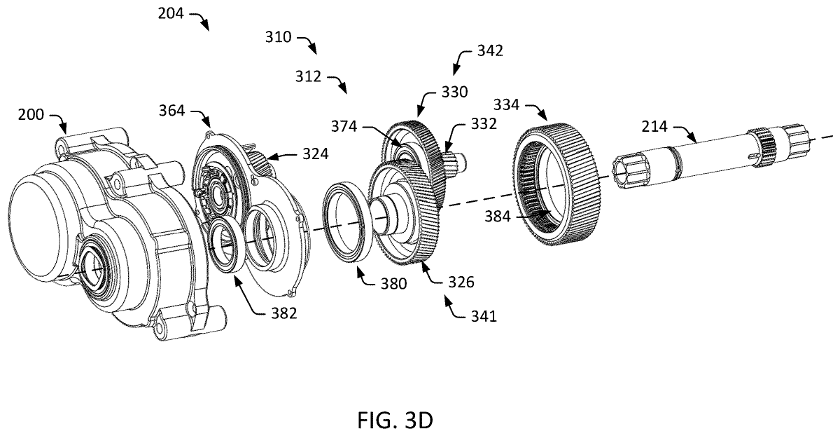

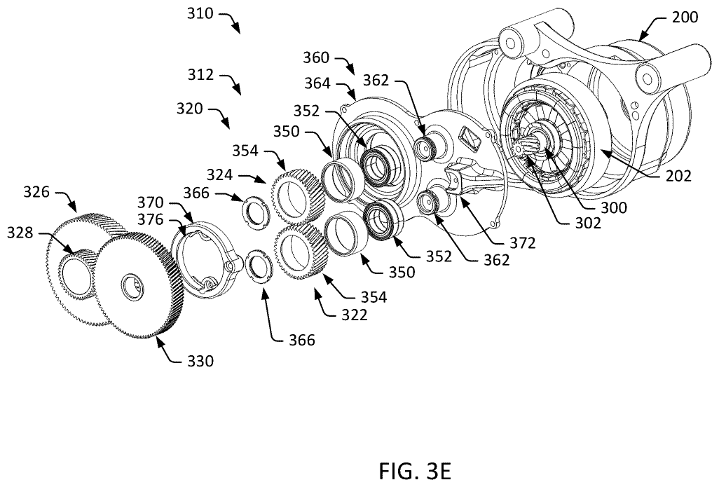

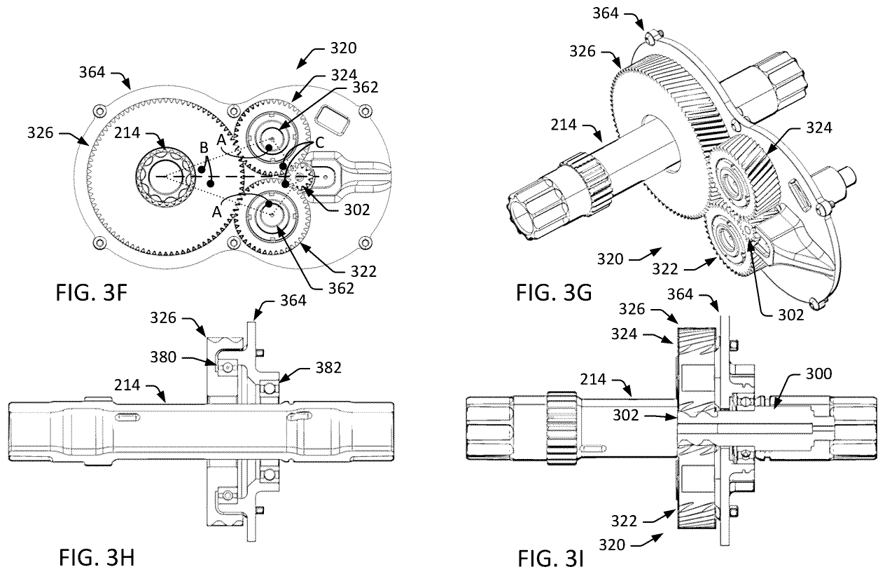

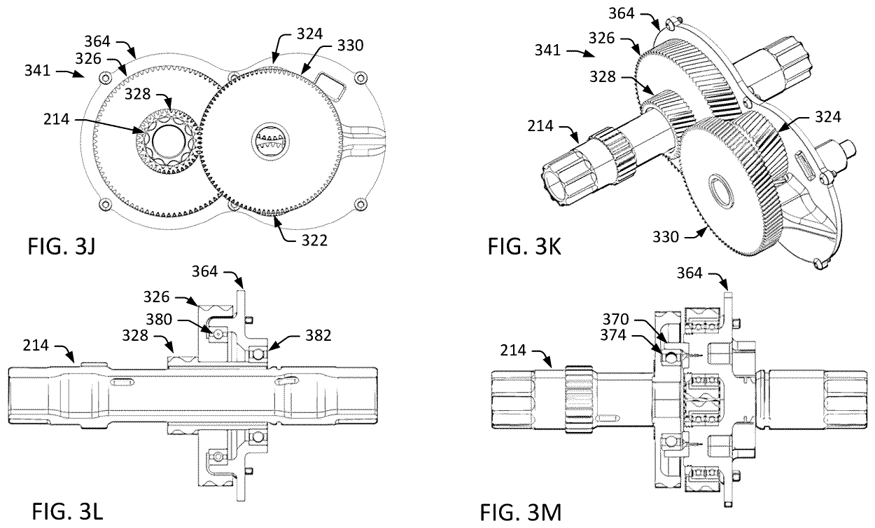

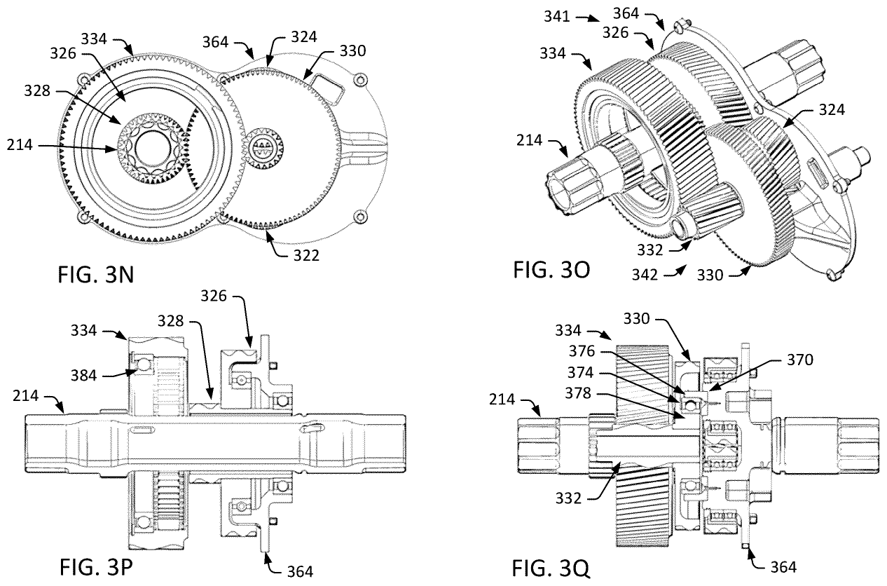

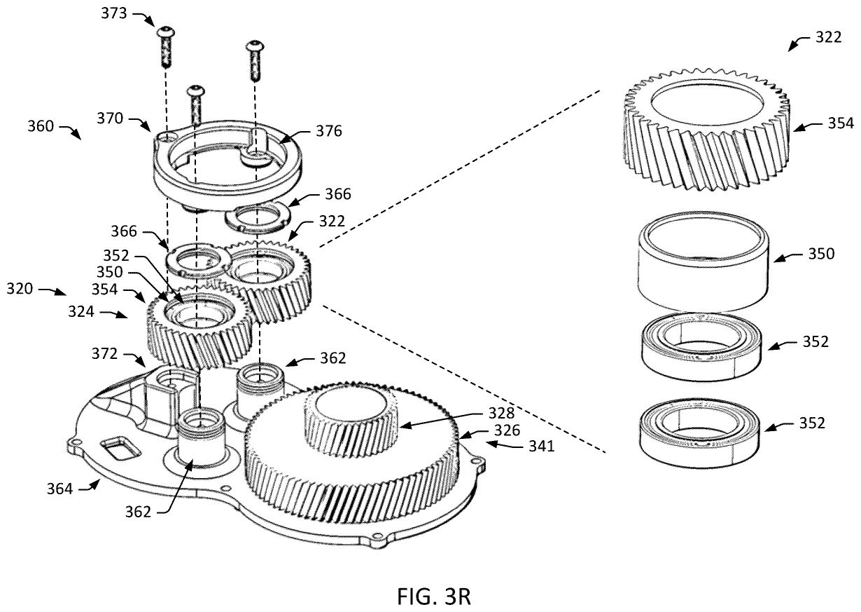

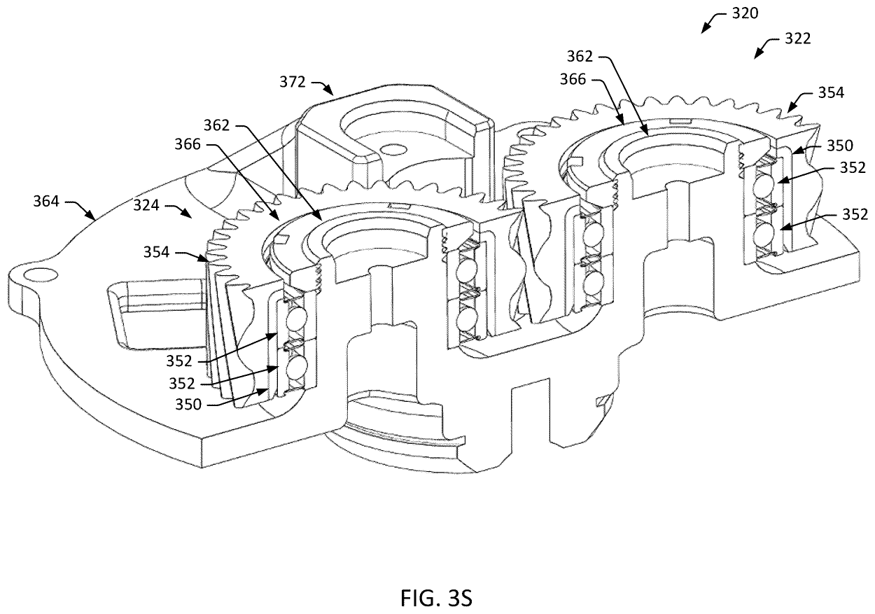

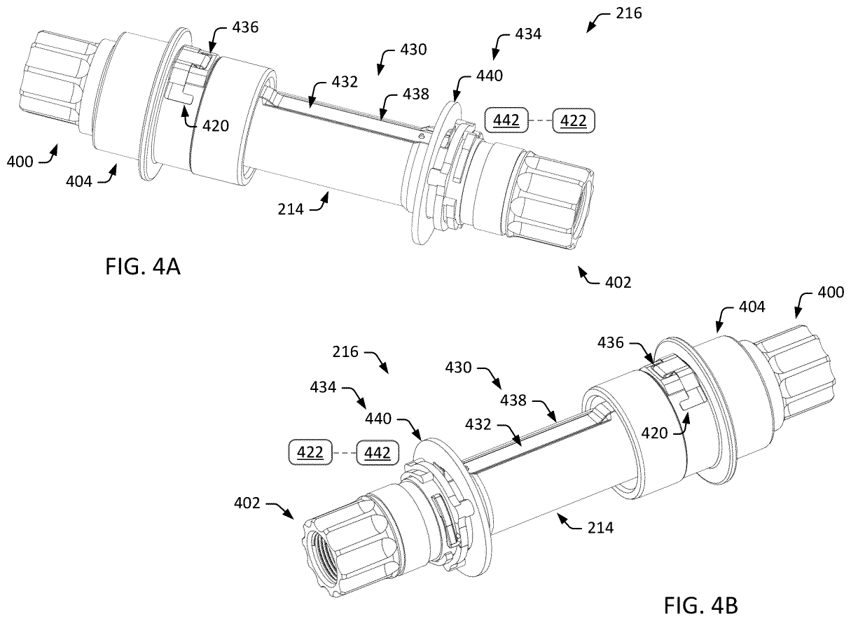

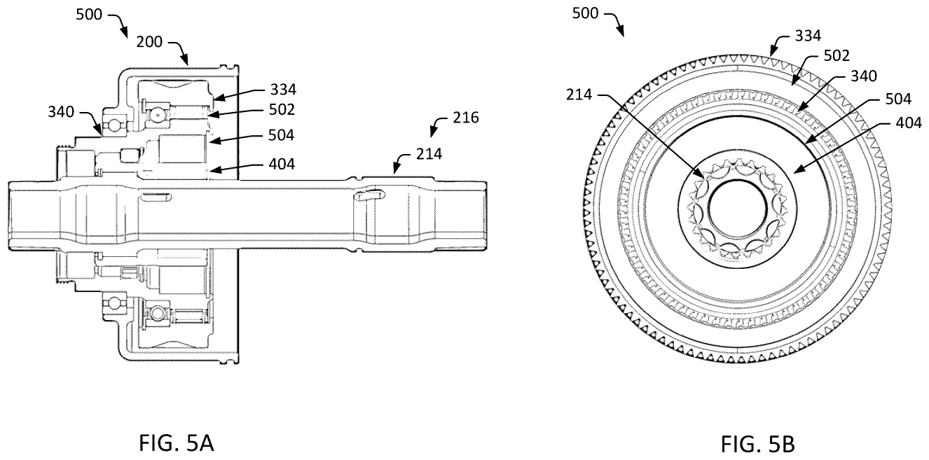

FIGS. 1A and 1B are diagrams that illustrate respective “drive side” and “non-drive side” views of a vehicle system 100 in accordance with one or more embodiments. In the illustrated embodiment, vehicle system 100 is a motorized vehicle system, specifically an electronic bicycle system (or “e-bike”) having a frame 102, a wheel system (or “wheels”) (e.g. wheels including a front wheel and rear wheel) 104, and a vehicle drive system 106 including a wheel drive system 107 (e.g., including a linkage based drive system, such as a chain or belt based drive system) and a mid-drive system (or “mid-drive”) 108 (e.g., a dual-drive, motor and human powered drive system). Mid-drive system 108 is mounted to frame mounting points about the bottom bracket 109 of frame 102 and is engaged with wheel drive system 107 to drive rotation of a rear wheel 104. FIGS. 2A and 2B are diagrams that illustrate respective “drive side” and “non-drive side” perspective views of vehicle drive system 106 in accordance with one or more embodiments. FIGS. 3A-3S are diagrams that illustrate various views of mid-drive 108 system in accordance with one or more embodiments. FIGS. 3R-3S are diagrams that illustrate relatively detailed views of the mounting configuration of the parallel axis idler gears in accordance with one or more embodiments. FIGS. 4A-4B are diagrams that illustrate various views of a torque sensing system incorporating a flex circuit in accordance with one or more embodiments. FIGS. 5A and 5B are diagrams that illustrate various views of a clutch system in accordance with one or more embodiments. For purposes of illustration and explanation, vehicle system 100 may be referred to here as an “e-bike” or “bike.” “Drive side” may refer to a side of a vehicle having a drive mechanism. For example, in the case of a bike, “drive side” generally refers to a side of the bicycle having a spider, chain, and rear wheel cassette, typically the right side of the bike.

In some embodiments, mid-drive 108 is a dual-drive system. For example, (referencing FIGS. 1, 2, 3A) mid-drive 108 incorporates a motor drive system 110 and a pedal drive system 112. As described, each of motor drive system 110 and pedal drive system 112 may have outputs couplable to wheel drive system 107 to drive propulsion of bike 100. For example, each of motor drive system 110 and pedal drive system 112 may have an output that is operable to transmit a respective drive torque to a chainring spider 114 of wheel drive system 107 that is, in turn, operable to transmit a corresponding torque to a linkage 116 (e.g., a chain, a belt, or the like) that is operable to, in turn, transmit a corresponding torque to rear wheel 104 (e.g., to a cassette coupled to a hub of rear wheel 104b) to impart torque on, and drive rotation of, rear wheel 104. Although certain embodiments are described in the context of torque transfer via a chainring spider (e.g., chainring spider 114) for the purpose of illustration, embodiments may employ any suitable torque transfer system, such as a direct mount chainring, belt pinion, or the like.

In some embodiments, motor drive system 110 includes components (e.g., a motor and gear system) operable to generate a torque that can be employed to propel bike 100. For example, (referencing FIGS. 2 and 3A) motor drive system 110 may include a mid-drive housing (e.g., a “motor housing” or “motor casing”) 200 encapsulating a drive motor (e.g., a battery powered electric motor) 202 and a drive gear system (e.g., a mid-drive gear box system including gear reduction stage) 204. In such an embodiment, drive motor 202 may be operable to output a “motor” torque that is provided as input to drive gear system 204, and drive gear system 204 may be operable to output a corresponding “drive” torque that can be routed for driving wheel drive system 107.

In some embodiments, pedal drive system 112 includes components (e.g., pedals, crankarms, and a spindle system) operable to deliver a human supplied torque (e.g., a rider supplied torque) that can be employed to propel bike 100. For example, (referencing FIGS. 1, 2, and 3A) pedal drive system 112 may include pedals 210 coupled to respective right (e.g., drive side) and left (e.g., non-drive side) crankarms 212 that are coupled to respective right and left ends of a spindle body 214 of a spindle system 216. In such an embodiment, when a rider (e.g., a human) applies force on a pedal 210, the force is transferred by way of a respective crankarm 212 to generate a corresponding “pedal” torque that is transmitted into a respective end of spindle body 214, and spindle system 216 is operable to output a corresponding “drive” torque that can be routed for driving wheel drive system 107.

In certain embodiments, mid-drive 108 incorporates a clutch system (e.g., a dual clutch system) operable to regulating routing drive torques generated by motor drive system 110 or pedal drive system 112 for use in propelling bike 100. For example, (referencing FIGS. 5A and 5B) mid-drive 108 may include a clutch system 500 having a motor clutch 502 and a pedal clutch (or “human clutch”) 504. Motor clutch 502 may be operable to selectively engage an output of motor drive system 110 (e.g., couple an output gear 334) to a clutch output shaft 340), to provide for transmission of drive torque generated by motor drive system 110 to output shaft 340 (e.g., for driving wheel drive system 107). Pedal clutch 504 may be operable to selectively engage an output of pedal drive system 112 (e.g., couple a torque tube 404 to clutch output shaft 340), to provide for transmission of drive torque generated by pedal drive system 112 to output shaft 340 (e.g., for driving wheel drive system 107). In some embodiments, motor clutch 502 enables the pedaling of the bike and transfer of pedal torque to output shaft 340 without back driving the gear box and motor, which can provide relatively drag-free pedaling (e.g., similar to a motorless bike).

In some embodiments, motor drive system 110 provides one source of propulsion (e.g., by way of motor sourced torque) and pedal drive system 112 provides another source of propulsion (e.g., manual (or “human”) pedaling sourced torque). In such an embodiment, motor drive system 110 and pedal drive system 112 may supply power to wheel drive system 107 allowing the bike to be propelled either by a motor alone, by pedaling alone, or by a combination of both. For example, motor drive system 110 may harness torque generated by its motor to provide a first, motor generated drive torque that is capable of being supplied to wheel drive system 107, pedal drive system 112 may harness torque generated by pedaling of a rider (e.g., including engagement of a pedal that includes applying a force to the pedal, which combined with transfer through the length of a crankarm, generates a corresponding torque (e.g., a “pedal input torque”)) to provide a second, human generated drive torque that is capable of being supplied to wheel drive system 107, and clutch system 500 may selectively engage one or both of motor clutch 502 and pedal clutch 504 to generate a corresponding third drive torque (e.g., a total/sum of the torque(s) transmitted by clutch system 500) that is delivered to wheel drive system 107. This may, for example, include clutch system 500 transmitting the third drive torque to chainring spider 114, which is operable to transmit a corresponding torque to linkage 116 (e.g., a chain, a belt, or the like), which is operable to transmit a corresponding torque to rear wheel 104 (e.g., to a cassette coupled to a hub of rear wheel 104b) to impart torque on, and rotation of, rear wheel 104.

In some embodiments, drive motor 202 includes an output shaft that transfers power generated by the motor in the form of rotation. For example, (referencing FIGS. 3A and 3E) drive motor 202 may have a motor output shaft 300 that is operable to rotate with rotational speed and torque to transfer power generated by drive motor 202. As illustrated, motor output shaft 300 may be coupled to, or include a pinion gear (or “drive gear”) 302. In some embodiments, pinion gear 302 is operable to transfer associated torque generated by drive motor 202 to gears of drive gear system 204. For example, pinion gear 302 may be operable to engage with, and transfer a motor torque to idler gears 322 and 324 of drive gear system 204.

In some embodiments, drive motor 202 is an electric motor. For example, drive motor 202 may be a battery-powered motor. In such an embodiment, a battery or similar power source may be located on e-bike 100, such as mounted the frame 102. In some embodiments, drive motor 202 is controlled by an onboard electronic controller (e.g., controller 422) that regulates power delivery based on rider input, such as throttle position or pedaling effort. In some embodiments, drive motor 202 includes integrated sensors to monitor key parameters like speed, temperature, and torque, which may facilitate dynamic adjustment of performance for optimal efficiency and rider experience.

In some embodiments, gear system 204 includes a gear reduction stage. For example, (referencing FIG. 3A), gear system 204 may include a gear reduction stage 310 operable to reduce rotational speed and increase torque relative to a rotational input. In some embodiments, gear reduction stage 310 includes a series of reduction stage gears operable to reduce rotational speed and increase torque of an input. For example, (referencing FIG. 3A and 3E) gear reduction stage 310 includes a series of reduction stage gears 312 operable to receive rotational input of motor output shaft 300, including a motor torque, and provide a rotational output having first drive torque that is greater than the corresponding motor torque. Such a configuration may enable mid-drive 108 to generate a relatively high-torque, low-speed output from a relatively low-torque, high-speed drive motor 202.

In some embodiment, reduction stage gears 312 include a series of gears extending between an input gear and an output gear. For example, (referencing FIG. 3A) reduction stage gears 312 may include a first gear reduction stage including pinon gear 302 (or “input gear”) (e.g., fixedly coupled to motor output shaft 300), a first gear mesh including a set of idler gears (or “idler gearset”) 320 (e.g., including a first idler gear 322 and a second idler gear 324), a second gear mesh including a first concentric gear 326 (e.g., a second gear disposed concentric to spindle body 214). A second gear reduction stage including a second concentric gear 328 (e.g., a third gear fixedly coupled to first concentric gear 326 and disposed concentric to spindle body 214), a first intermediate gear 330 (e.g., a fourth gear disposed not concentric to spindle body 214). A third gear reduction stage including a second intermediate gear 332 (e.g., a fifth gear fixedly coupled to first intermediate gear 330 and disposed not concentric to spindle body 214) and an output gear 334 (e.g., a sixth gear disposed concentric to spindle body 214). In such an embodiment, first concentric gear 326, and second concentric gear 328 may be coaxial and rotate together as a single unit (e.g., due to being fixedly coupled to one another), forming a first compound gear 341. First intermediate gear 330 and second intermediate gear 332 may be coaxial and rotate together as a single unit (e.g., due to being fixedly coupled to one another), forming a second compound gear. 342. All of the reduction stage gears 312 may have a rotational axis that is parallel to one another and the rotational axes of spindle body 214, torque tube 404, spider 114, and output shaft 340. Some or all of reduction stage gears 312 may be helical gears, spur gears, or some combination thereof. First concentric gear 326, second concentric gear 328, and output gear 334 may have rotational axes that are concentric with the rotational axes of spindle body 214, torque tube 404, spider 114, and output shaft 340.

In some embodiments, reduction stage gears 312 include helical gears that mesh with one another to transfer torque. For example, pinon gear 302 may be a helical gear (e.g., a 12 tooth (T) helical gear), first idler gear 322 and a second idler gear 324 may each be a helical gear (e.g., a 40T helical gear), first concentric gear 326 may be a helical gear (e.g., an 84T helical gear), second concentric gear 328 may be a helical gear (e.g., a 41T helical gear), first intermediate gear 330 may be a helical gear (e.g., a 95T helical gear), second intermediate gear 332 may be a helical gear (e.g., an 18T helical gear), and output gear 334 may be a helical gear (e.g., a 93T helical gear). In such an embodiment, torque may be transferred as follows:
(1) pinon gear 302 may receive torque (“input torque” or “motor torque”) from motor output shaft 300 by way of fixed coupling therebetween.
(2a) pinon gear 302 may mesh with first idler gear 322 to transfer at least a portion of an input torque (a “first pinion output torque” or a “first idler input torque”) (e.g., half of the motor torque) from pinon gear 302 to first idler gear 322;
(2b) pinon gear 302 may mesh with second idler gear 324 to transfer at least a portion of an input torque (“second pinion output torque” or “second idler input torque”) (e.g., the other half of the motor torque) from pinon gear 302 to second idler gear 324;
(3a) first idler gear 322 may mesh with first concentric gear 326 to transfer a torque (“first idler gear output torque” or “first concentric input torque”) to first concentric gear 326;
(3b) second idler gear 324 may mesh with first concentric gear 326 to transfer a torque (“second idler gear output torque” or “second concentric input torque”) to first concentric gear 326;
(4) first concentric gear 326 may, by way of directly coupling, transfer torque (“first concentric output torque” of “second concentric input torque”) to second concentric gear 328;
(5) second concentric gear 328 may mesh with first intermediate gear 330 to transfer a torque (“second concentric output torque” or “first intermediate input torque”) to first intermediate gear 330;
(6) first intermediate gear 330 may, by way of directly coupling, transfer a torque (“first intermediate output torque” or “second intermediate input torque”) to second intermediate gear 332; and
(7) second intermediate gear 332 may mesh with output gear 334 to transfer a torque (“second intermediate output torque” or “output gear input torque”) to output gear 334.

Output gear 334 may be selectively engaged by motor clutch 502 of clutch system 500 to, for example, transfer a torque (“first output torque” or “motor drive output torque”) to a mid-drive output shaft 340 (e.g., coupled to chainring spider 114) that may, for example, be used to drive wheel drive system 107.

Accordingly, in some embodiments, torque flows through the system, starting from the motor and moving through a series of gears until it reaches the output. For example, torque starts from motor output shaft 300 and is transferred to pinion gear 302, pinion gear 302 transfers torque to two idler gears: first idler gear 322 and second idler gear 324, the torque is split between these two idler gears (e.g., half to each), first idler gear 322 transfers its torque to the first concentric gear 326, second idler gear 324 also transfers its torque to first concentric gear 326 (so that both idler gears contribute to the torque received by first concentric gear 326), first concentric gear 326 directly couples to and transfers torque to second concentric gear 328, second concentric gear 328 transfers torque to the first intermediate gear 330, first intermediate gear 330 directly couples and transfers torque to second intermediate gear 332, and second intermediate gear 332 transfers torque to output gear 334, and output gear 334, when engaged by motor clutch 502, transfers torque to mid-drive output shaft 340, which may be used to drive wheel drive system 107 and, in turn, rotation of rear wheel 104 of bike 100.

In some embodiments, idler gearset 320 is a “parallel axis” gearset in the sense that each of its idler gears 322 and 324 have axes that are parallel to one another. Idler gearset 320 may, for example, be described as a constrained system based on its synchronized meshing of first idler gear 322 and second idler gear 324 between pinion gear 302 to first concentric gear 326 to transfer torque from pinion gear 302 to first concentric gear 326. The gears may have fixed gear ratios with number of teeth on each gear (e.g., 12T on pinion 302, 40T on idler gears 322 and 324, and 84T on first concentric gear 326) determines the gear ratios, ensuring a fixed relationship between the input and output speeds. The gears may impart coordinated motion, where rotation of pinion gear 302 is transmitted to idler gears 322 and 324, which in turn transmit this motion to first concentric gear 326. Thus, the gears may be designed so that their rotations are synchronized, maintaining a precise mechanical relationship.

In some instances, reduction stage gears 312 are formed of a suitable material, such as a metal, polymer, or the like. For example, reduction stage gears 312 may include idler gears 322 and 324 formed of a non-metallic material (e.g., plastic), and the other reduction stage gears 312 formed of a metal material. The use of non-metallic material, such as plastic, in idler gears 322 and 324 may, for example, dampen vibration, reduce noise of gearbox transmission, reduce weight, and the like. In some embodiments, idler gears 322 and 324 are constructed from a suitable polymer (e.g., plastics), such as Polyether ether ketone (PEEK), Nylon, Acetal, or the like. Materials and configurations, such as combinations of materials, engineered polymers, filled materials, or the like, may be employed to enhance performance. To further improve reliability, idler gears 322 and 324 (or other plastic gears) may be equipped with inner gear sleeves. For example, (referencing FIG. 3E), idler gears 322 and 324 may each include a respective idler gear inner sleeve 350 disposed internal to idler gears 322 and 324 such that the sleeve provides an interface between a supporting surface (e.g., idler gear bearings 352) and an outer relatively flexible (e.g., relatively low hardness and compliant) plastic outer idler gear sleeve 354 (e.g., including helical gearing). Such rigid inner sleeves may help prevent compression and creep of relatively flexible (e.g., plastic) gearing material under the effect of cyclic loading against an internal support, such as bearings. The ability to use a relatively flexible lightweight gear material, such as a plastic, while maintaining rigidity and resistance to compression, creep, and wear, may enable a relatively large amount of torque to be transmitted quietly by way of two relatively small, lightweight gears. The use of two idler gears 322 and 324 as opposed to a single gear may enable a relatively narrow gear width due to the ability to transmit a given torque by way of two relatively narrow idler gears 322 and 324, as opposed to a single wide gear that may be need to efficiently and effectively transmit the same given torque. Such an arrangement may contribute to a relatively narrow/compact gear reduction stage 310 and mid-drive unit 108. In some configurations, use of a single, relatively flexible gear (e.g., a plastic gear) can be a limiting factor for torque transfer. The use of two internally sleeved gears can enable reduced gearing footprint, gear-box noise reduction, and the like, while maintaining capability and durability for the transfer of torque.

In some embodiments, idler gearset support system 360 is provided to support operation of other reduction stage gears 312 and components of gear reduction stage 310. For example, (referencing FIGS. 3E, 3R and 3S) idler gearset support system 360 may include two posts 362 that each extend from a rigid motor faceplate (“faceplate”) 364 disposed adjacent drive motor 202, and inside and rigidly coupled to housing 200. Each of idler gears 322 and 324 is disposed about a respective one of posts 362, with idler gear bearings 352 disposed between idler gears 322 and 324 and posts 362. In some embodiments, bearings 352 include, for each idler gear 322 or 324 and post 362, a stacked set of circular bearings 352 or the like (e.g., a needle bearing) disposed between the exterior of post 362 and an interior of idler gear 322 or 324. For example, as illustrated, stacked set of circular bearings 352 may include two circular bearings 352 disposed over post 362 and inside of idler gear inner sleeve 350 of idler gear 322 or 324. Bearings 352 may, for example, be press fit into idler gear inner sleeves 350, slide fit over post 362, and be retained by respective bearing retainers 366 secured to distal ends of post 362 (e.g., locknuts threaded onto distal ends of post 362). Bearing 352 may be designed and disposed to support a moment load that is perpendicular to axial direction of idler gears 322 and 324, such as a load generated by the opposing thrust loads arising from the helix angle meshes between idler gears 322 and 324 and pion gear 302 and first concentric gear 326. Bearing retainers 366 may, for example, be a castle nut style retainer. Bearing retainers 366 may for example, be secured to generate a preload on bearings 352 to reduce play and vibration, which may contribute to reduced gear-box noise and improved torque transfer and durability.

In some embodiments, post 362 of idler gearset support system 360 have their proximal ends rigidly coupled to faceplate 364. This may facilitate maintaining relative positioning of idler gears 322 and 324 during operation. In some embodiments, distal ends of posts 362 of idler gearset support system 360 are rigidly coupled by way of an idler bearing support hoop (“bearing hoop”) 370. This may, in turn, provide relatively precise meshing of idler gears 322 and 324 with pion gear 302 and first concentric gear 326, e.g., by reducing post deflection under load, and enhance performance of gear reduction stage 310 and mid-drive unit 308. For example, (referencing FIGS. 3E, 3R and 3S) bearing hoop 370 may include a rigid member (e.g., formed of aluminum, magnesium, steel, another metal, or the like) rigidly coupled to distal end of posts 362 and a pinion gear surround protrusion 372 extending from faceplate 364 by way of fasteners (e.g., screws) 373. In such an embodiment, bearing hoop 370 facilitate maintaining relative positioning of distal end of posts 362, helping to reduce deflection of posts 362 (e.g., due to moments generated by applied torque or the like) and associated lateral movement/shifting idler gears 322 and 324 of during operation.

In some embodiments, idler gearset 320 is arranged to have a position relative to pion gear 302 and first concentric gear 326. For example, (referencing FIGS. 3F), a first angle (A) between lines extending from the rotational axes of pinion gear 302 and first concentric gear 326 the rotational axis of idler gears 322 and 324 may be about 90 degrees or greater (e.g., about 90 degrees, or about 105 degrees (with angle B about 20 degrees and angle C about 55 degrees relative to a centerline passing through the rotational axes of pinion gear 302 and first concentric gear 326), or the like). This angle and position may be set to ensure proper gear meshing of a constrained gear system.

In some embodiments, bearing hoop 370 of idler gearset support system 360 is operable to support other reduction stage gears 312. For example, bearing hoop 370 may support a bearing 374 that interfaces with and supports first intermediate gear 330. In some embodiments, bearing hoop 370 includes a recess or similar element that accepts bearing 374. For example, (referencing FIG. 3E and 3Q) bearing hoop 370 may include a recess 376 that accepts bearing 374 and first intermediate gear 330 may include a protrusion 378 that accepts bearing 374, with an exterior of bearing 374 slip fit into recess 376 of bearing hoop 370 and an interior of bearing 374 press fit over protrusion 378 of first intermediate gear 330. Such an arrangement may support rotation of bearing 374 and first intermediate gear 330 (and second intermediate gear 332 coupled thereto). Thus, for example, first intermediate gear 330 (and second intermediate gear 332 coupled thereto) may “float” in a middle portion of housing 200 by way of a cantilevered support of idler gearset support system 360 and its components extending from faceplate 364. Such a configuration may minimize components to support first intermediate gear 330 (and second intermediate gear 332) in a compact system with gears concentric to the spindle, and, in turn, contribute to a relatively simple and compact gear reduction stage and mid-drive unit. For example, the use of idler gearset support system 360 may eliminate a need for a central support to pass through first intermediate gear 330 (and second intermediate gear 332) and extending from one or both sides of housing, which may cause physical interference or other interaction with idler gears 322 and 324 or output gear 334 or require positioning of gear and other components of gear reduction stage 310 further from spindle, in a less compact form.

As noted, in some embodiments, one or more reduction stage gears 312 are disposed concentric (or “coaxial”) to spindle body 214. In such an embodiment, rotational axes of concentric components may be coincident (or “coaxial”). For example, (referencing FIG. 3A-3D, 3H, 3I, 3L, 3M, and 3P) first concentric gear 326, second concentric gear 328, and output gear 334 may be disposed concentric to spindle body 214. This may include each of first concentric gear 326, second concentric gear 328, and output gear 334 being aligned along the same rotational axis as spindle body 214, sharing a common center of rotation. In such an arrangement, rotational axes of first concentric gear 326, second concentric gear 328, output gear 334, and the spindle coincide with one another. In some embodiments, one or more reduction stage gears 312 disposed concentric (or “coaxial”) to spindle body 214, are not coupled to spindle body 214. For example, each of first concentric gear 326, second concentric gear 328, and output gear 334 may have a circular opening in its center, having an internal diameter (and external helical gearing) that is larger than the external diameter of a corresponding portion of spindle 214 to be located proximate the gear, and spindle body 214 may extend through the circular openings of the gears without spindle body 214 contacting (or “touching”) the first concentric gear 326, second concentric gear 328, and output gear 334. Thus, the first concentric gear 326, second concentric gear 328, and output gear 334 may be “suspended” about spindle body 214. For example, (referencing FIG. 3F and 3L) a first concentric gear bearing 380 may be disposed between faceplate 364 and first concentric gear 326 to support first concentric gear 326 being disposed concentric to spindle body 214 and maintaining a gap between the exterior of spindle body 214 and the central opening of first concentric gear 326, such that first concentric gear 326 is operable to rotate concentrically about the spindle body 214 without physical interaction therebetween (e.g., without physical interference, touching, mechanical coupling or the like), such as coupling by way of a bearing disposed therebetween. Further, (referencing FIG. 3L) a second concentric gear bearing 382 may be disposed between faceplate 364 and second concentric gear 328 to support second concentric gear 328 being disposed concentric to spindle body 214 and maintaining a gap between the exterior of spindle body 214 and the central opening of second concentric gear 328, such that second concentric gear 328 is operable to rotate concentrically about spindle body 214 without physical interaction therebetween (e.g., without physical interference, touching, mechanical coupling, or the like), such as coupling by way of a bearing disposed therebetween. In such an embodiment, first compound gear 341 may be supported by bearings 380 and 382 that are fixed to faceplate 364 and may not derive support from spindle body 214. The combination of bearings 380 and 382 and rigid coupling of first and second concentric gears 326 and 328 may offset and support a bending moment resulting from the cantilevered arrangement of first and second concentric gears 326 and 328 extending toward a middle of housing 200. Also, (referencing FIG. 3P) an output gear bearing 384 may be disposed between a portion of clutch system 500 and output gear 334 to support output gear 334 being disposed concentric to spindle body 214 and maintaining a gap between the exterior of spindle body 214 and the central opening of output gear 334, such that output gear 334 is operable to rotate concentrically about spindle body 214 without physical interaction therebetween (e.g., without physical interference, touching, mechanical coupling or the like), such as coupling by way of a bearing disposed therebetween. The gap and corresponding lack of physical interaction may eliminate unwanted physical interference, such as contact, mechanical loading, or other interaction between spindle body 214 and surrounding gears that could cause friction, wear, or other mechanical issues. As described, in some embodiments, engagement of motor clutch 502 may operate to couple output gear 334 to other components, such as output shaft 340 (e.g., for driving wheel drive system 107), and in the case of pedal clutch 504 being engaged, there may be indirect coupling of output gear 334 to spindle system 216 and spindle body 312. The reduction and elimination of interference between rotating gears, such as that which may exists if a reduction stage gear 312 were support by a bearing slip fit about spindle body 312 and press fit into an interior of the reduction stage gears 312, may further enhance performance of mid-drive 108 by reducing noise and energy losses that would be attributed to such interaction, such as noise and friction loss of additional bearings disposed about spindle body 214.

In some embodiments, spindle system 216 includes spindle body 214 operable to receive user provided torque and a torque tube operable to transfer torque from spindle body 214 to other components of mid-drive 108. For example, (referencing FIGS. 3A, 4A and 4B) spindle body 214 may be a generally cylindrical body having a first/right end (“drive side end”) 400 and a second/left end (“non-drive side end”) 402, with a torque tube 404 coupled about spindle body 214. First end 400 may be splined to couple to a drive side crank arm 212 (having a drive side pedal 210), maybe splined to couple to a non-drive side crank arm 212 (having a non-drive side pedal 210). Torque tube 404 may be a cylindrical sleeve that is meshed or otherwise fixedly coupled to an exterior of spindle body 214. As illustrated, torque tube 404 may be located toward a drive side end 400 of spindle body 214. In such an embodiment, when assembled/mated with clutch system 500, torque tube 404 may be operable to transfer torque from spindle body 214 (e.g., a pedal torque generated by rider applying force to either pedal generating a moment about the spindle) to clutch system 500 (e.g., by way of pedal clutch 504) for use in driving wheel drive system 107. Aspects of operation of clutch system 500 and components noted above are described in more detail below with regard to at least FIGS. 5A and 5B.

In some embodiments, mid-drive 108 includes components to monitor inputs, operation, and performance of mid-drive 108 and various components. For example, in some embodiments, mid-drive 108 includes sensors (e.g., strain gauges or the like) to determine when (and how aggressively) a user is pedaling, and can make operational decisions (e.g., a controller increasing/decreasing power to drive motor 202) based thereon. In some embodiments, spindle system 216 includes sensors that are operable to monitor torque present at torque tube 404. For example, (referencing FIGS. 4A and 4B) spindle system 216 may include pedal torque sensors 420 (e.g., strain gauges or the like) that are operable to sense and report measurements of strain at torque tube 404. In some embodiments, measurements of strain at torque tube 404 or the like can be employed to monitor operations of mid-drive 108 or to make decisions concerning operation of mid-drive 108. For example, measurements of strain provided by a strain gauge type pedal torque sensors 420 may be acquired, and a control system of mid-drive 108 may use this information to determine when (and how aggressively) a user is pedaling, and, in turn, to make operational decisions, such as increasing/decreasing motor power and output torque. A pedal torque sensor 420 may include any suitable sensor. For example, pedal torque sensor 420 may include strain gauges mounted to the outside of the torque tube arranged in a dual pair of shear-mode strain gauges connected in a full-bridge configuration. Various patterns may be employed, for example, to minimize any strain readings that come from spindle bending along the spindle's axial axis, or any strain readings that come from compression of torque tube 404 due to sprag clutch engagement. Undesirable strains may be eliminated such that the strain gauges output measurements of pure torsional strain that is directly proportional to pedal input torque. Strain gauges may be oriented, for example, in a radial direction about torque tube 404, a longitudinal direction along torque tube 404, a 45-degree direction about torque tube 404, or at any other angle deemed to provide the an optimal signal.

In some embodiments, processing and control components of mid-drive 108 are located remote from sensing apparatuses, such as pedal torque sensors 420. For example, (referencing FIGS. 4A and 4B) strain gauge type pedal torque sensors 420 may be located on torque tube 404 proximate a drive side of spindle body 214 and mid-drive 108, and processing and control components of mid-drive 108 (e.g., controller 422) may be located proximate a non-drive side of spindle body 214 and mid-drive 108. In such an embodiment, signals or other information may need to be transmitted “across” mid-drive 108. For example, signals from strain gauge type pedal torque sensors 420 may be located on torque tube 404 may need to transmitted though or around gear reduction stage 310, from the drive side to the non-drive side of mid-drive 108. Due to rotation of components, power constraints, and size limitations, it may not be feasible to transmit such signals across mid-drive 108 wirelessly.

In some embodiments, spindle system 216 includes a circuit that is operable to transmit signals across mid-drive 108. For example, (referencing FIGS. 4A and 4B) spindle system 216 may include an electrical circuit (e.g., a “flex-circuit” or other system for carrying electrical signals, such as a twisted wire pair)) 430 that is operable to transmit signals across mid-drive 108, from a strain gauge type pedal torque sensor 420 disposed on torque tube 404 (located proximate a drive side of spindle body 214 and mid-drive 108) to controller 422 (located proximate a non-drive side of spindle body 214 and mid-drive 108). In some embodiments, flex circuit 430 includes a conductive element and transmission unit. For example, (referencing FIGS. 4A and 4B) flex circuit 430 may include a conductive element 432 (e.g., a ribbon cable, insulated trace, or the like) that is operable to transmit electrical signals from pedal torque sensor 420 along a length of spindle body 214, to rotating transmission unit 434. Pedal torque sensor 420 may be disposed on an exterior surface of torque tube 404, torque tube 404 may include a pass-through 436 (e.g., a hole or cut-out) to provide for routing of conductive element 432 though torque tube 404, to an interior of torque tube 404, and spindle body 214 may include a channel 438 (e.g., a recessed or enclosed channel) along its length that provides for routing of conductive element 432 along a length of spindle body 214 (e.g., inside of (or “under”) reduction stage gears 312, including first concentric gear 326, second concentric gear 328 and output gear 334). For example, conductive element 432 may be disposed in channel 438 such that is does not extend past the outer diameter of the associated surface of spindle body 214 and, thus does not contact or otherwise interfere with surrounding/concentric reduction stage gears 312. Such a configuration may enable signals to be transmitted across mid-drive 108, through/under multiple concentric gears, such as first concentric gear 326, second concentric gear 328 and output gear 334. Electrical circuit 430 and conductive element 432 may include any suitable communication system, such as (a) a polymer-film-and-patterned-metal-conductor-based flexible circuit, (b) a flexible electrical ribbon cable, or (c) two or more insulation-jacketed flexible electrically conductive wires wound helically around each other, or otherwise bound to one another in close proximity, including conductive paths operable to transmit electrical signals, or the like.

In some embodiments, transmission unit 434 includes a slip ring that is operable to transmit signals from conductive element 432 rotating with spindle body 214 to a relatively stationary conductive clement that forwards transmitted signals to controller 422. For example, transmission unit 434 may include a pedal assist system (PAS) rotor 440 (e.g., a conductive ring or series of rings that rotate along with spindle body 214 secures by a clip) and a counterpart PAS stator 442 (e.g., including brushes, contacts, or wireless methods that maintain electrical communication with the PAS rotor 436 as it turns). PAS rotor 440 and PAS stator 442 may be communicatively coupled by any suitable technique. For example, PAS rotor 440 and PAS stator 442 may be communicatively coupled by way of one or more of the following: optical coupling, inductive coupling, capacitive coupling, near-field transmission, rotary brushes, or the like.

FIGS. 5A and 5B are diagrams that illustrate various views of clutch system 500 in accordance with one or more embodiments. In the illustrated embodiment, clutch system 500 includes dual clutch system that is operable to selectively transmit inputs from two sources. For example, clutch system 500 may include a motor clutch 502 and pedal clutch (or “human clutch”) 504. In some embodiments, motor clutch 502 is operable to regulate routing of drive torque generated by motor drive system 110, and pedal clutch 504 is operable to regulate routing of drive torque generated by pedal drive system 112, for use in propelling bike 100. For example, (referencing FIGS. 5A and 5B). Motor clutch 502 resides between an exterior of clutch output shaft 340 and an interior of output gear 334 and is operable to selectively couple output gear 334 to clutch output shaft 340 (e.g., to provide for transmission of drive torque generated by motor drive system 110 to output shaft 340 for driving wheel drive system 107). Pedal clutch 504 resides between an exterior of torque tube 404 and an interior of clutch output shaft 340 (e.g., to provide for transmission of drive torque generated by pedal drive system 112 to output shaft 340 for driving wheel drive system 107). In some embodiments, motor clutch 502 or pedal clutch 504 may be engaged individually or in combination to regulate delivery of torque to clutch output shaft 340 and wheel drive system 107. Disengeagment of motor clutch 502 or pedal clutch 504 when it is not supplying torque may enhance performance by reducing interaction (e.g., interference/friction) and reducing associated noise.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here, parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors/modules/applications described here.

Throughout this application, the word “may” is used in a permissive sense (meaning having the potential to), rather than the mandatory sense (meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (e.g., by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:
1. A motorized bicycle system comprising:
   an electric drive system configured to output a first drive torque, the electric drive system comprising:
      an electric drive motor configured to output a motor torque; and
      a mid-drive gear box system configured to receive the motor torque and output the first drive torque;
   a pedal drive system configured to output a second drive torque, the pedal drive system comprising a spindle system configured to receive a pedal input torque and output the second drive torque; and
   a clutch system configured to regulate routing of the first drive torque and the second drive torque to generate a third output torque configured to be delivered to a chainring of a wheel drive system of a bicycle;
   the mid-drive gear box system comprising a gear reduction stage comprising:
      two or more concentric gears, each concentric gear of the two or more concentric gears is disposed concentric to a spindle body of the spindle system of the pedal drive system; and
      a parallel axis idler gearset comprising:
         a first idler gear configured to engage a first gear of the gear reduction stage and a second gear of the gear reduction stage and to transmit torque from the first gear to the second gear; and
         a second idler gear configured to engage the first gear of the gear reduction stage and the second gear of the gear reduction stage and to transmit torque from the first gear to the second gear.
2. The system of embodiment 1, wherein the electric drive motor comprises a battery powered electric motor.
3. The system of embodiment 1 or 2, wherein the pedal drive system comprises a crankarm coupled to the spindle system and a pedal coupled to the crankarm, and wherein user engagement of the pedal is configured to generate the pedal input torque.
4. The system of any one of embodiment 1-3, wherein the clutch system is configured to selectively engage one or both of (a) an output of the mid-drive gear box system, and (b) an output of the spindle system, to generate the third output torque.
5. The system of any one of embodiment 1-4, wherein the two or more concentric gears further comprise a third concentric gear disposed concentric to the spindle body of the pedal drive system.
6. The system of any one of embodiment 1-5, wherein the two or more concentric gears comprise:
   a first compound gear disposed concentric to the spindle body; and
   an output gear disposed concentric to the spindle body,
   the first compound gear comprising a first compound gear input gear and a first compound gear output gear fixedly coupled to the first compound gear input gear, and
   the output gear configured to be selectively engaged by the clutch system.
7. The system of embodiment 6, wherein the second gear of the gear reduction stage comprises the first compound gear.
8. The system of embodiment 6, wherein the gear reduction stage comprises:
   a second compound gear comprising:
      a second compound gear input gear; and
      a second compound gear output gear,
   the second compound gear input gear configured to engage the first compound gear output, and
   the second compound gear output gear configured to engage the output gear.
9. The system of any one of embodiment 1-8, wherein the gear reduction stage comprises intermediate gearing, configured to engage a first concentric gear of the two or more concentric gears and to engage a second concentric gear of the two or more concentric gears, to transfer torque from the first concentric gear to the second concentric gear.
10. The system of any one of embodiment 1-9, wherein the spindle body is configured to rotate free of physical interaction with the two or more concentric gears of the mid-drive gear box system.
11. The system of claim 1-10, wherein a bearing of a compound gearset is supported by post members about which the idler gears are disposed.
12. The system of any one of embodiment 1-11, wherein the first idler gear is formed of a polymer and the second idler gear is formed of a polymer.
13. The system of any one of embodiment 1-12, wherein the first idler gear, the second idler gear, the first gear of the gear reduction stage, and the second gear of the gear reduction stage are configured to operate as a constrained gear system.
14. The system of any one of embodiment 1-13, wherein the first gear of the gear reduction stage comprises a motor pinon gear coupled to an output of the electric drive system.
15. The system of any one of embodiment 1-14, wherein the second gear of the gear reduction stage comprises a first compound gear disposed concentric to the spindle body of the spindle system of the pedal drive system.
16. The system of any one of embodiment 1-15, further comprising:
   a torque sensing circuit comprising:
      a spindle torque sensor coupled to a spindle torque tube of the spindle system, the spindle torque tube disposed concentric to the spindle body of the spindle system and proximate a first portion of the spindle body, the spindle torque tube configured to receive torque resulting from the pedal input torque, and the torque sensor configured to sense torque acting on the spindle torque tube; and
      an electrical circuit coupled to the spindle torque sensor and extending proximate the spindle body to a location proximate a second portion of the spindle body, the electrical circuit configured to transmit signals produced by the spindle torque sensor to the location proximate the second portion of the spindle body, the location proximate the first portion of the spindle body being on a first side of one or more of the two or more concentric gears and the location proximate the second portion of the spindle body being on a second side of the one or more of the two or more concentric gears.
17. The system of any one of embodiment 1-16, the wheel drive system comprising a chain or belt configured to transmit the third output torque to drive a wheel of the bicycle into rotation.
18. A vehicle drive system comprising:
   a motor drive system configured to output a first drive torque, the motor drive system comprising:
      a drive motor configured to output a motor torque; and
      a drive gear system configured to receive the motor torque and output the first drive torque; and
   a pedal drive system comprising a spindle system comprising a spindle body,
   the drive gear system comprising a gear reduction stage comprising:
      concentric gears comprising:
         a first concentric gear disposed concentric to the spindle body of the pedal drive system; and
         a second concentric gear disposed concentric to the spindle body of the pedal drive system.
19. The system of embodiment 18, wherein the motor comprises a battery powered electric motor.
20. The system of embodiment 18 or 19, the spindle system configured to receive a pedal input torque and output a second drive torque.
21. The system of embodiment 20, wherein the pedal drive system comprises a crankarm coupled to the spindle system and a pedal coupled to the crankarm, and wherein user engagement of the pedal is configured to generate the pedal input torque.
22. The system of embodiment 20, further comprising a clutch system configured to regulate routing of the first drive torque and the second drive torque to generate a third output torque configured to drive a wheel of the vehicle.
23. The system of embodiment 22, wherein the third output torque is delivered to a chainring of a chain drive system of the vehicle.
24. The system of any one of embodiment 18-23, further comprising a third concentric gear disposed concentric to the spindle body of the pedal drive system.
25. The system of any one of embodiment 18-24, wherein:
   the first concentric gear comprises a first compound gear disposed concentric to the spindle body, and
   the second concentric gear comprises an output gear disposed concentric to the spindle body,
   the first compound gear comprising a first compound gear input gear disposed concentric to the spindle body and a first compound gear output gear fixedly coupled to the first compound gear input gear and disposed concentric to the spindle body.
26. The system of embodiment 25, wherein the gear reduction stage comprises:
   a second compound gear comprising:
      a second compound gear input gear; and
      a second compound gear output gear,
   the second compound gear input gear configured to engage the first compound gear output, and
   the second compound gear output gear configured to engage the output gear.
27. The system of embodiment 25, wherein the output gear is configured to be selectively engaged by a clutch system.
28. The system of any one of embodiment 18-27, wherein the gear reduction stage comprises intermediate gearing configured to engage the first concentric gear and to engage the second concentric gear, to transfer torque from the first concentric gear to the second concentric gear.
29. The system of any one of embodiment 18-28, wherein the drive gear system further comprises:
   a parallel axis idler gearset comprising:
      a first idler gear configured to engage a first gear of the gear reduction stage and a second gear of the gear reduction stage and to transmit torque from the first gear to the second gear; and
      a second idler gear configured to engage the first gear of the gear reduction stage and the second gear of the gear reduction stage and to transmit torque from the first gear to the second gear.
30. The system of embodiment 29, wherein the second gear of the gear reduction stage comprises the first concentric gear, the first concentric gear comprising a compound gear disposed concentric to the spindle body.
31. The system of embodiment 29, wherein the first idler gear, the second idler gear, the first gear of the gear reduction stage, and the second gear of the gear reduction stage are configured to operate as a constrained gear system.
32. The system of any one of embodiment 18-31, further comprising:
   a torque sensing system comprising:
      a spindle torque sensor coupled to a spindle torque tube of the spindle system, the spindle torque tube disposed concentric to the spindle body of the spindle system and proximate a first portion of the spindle body, the spindle torque tube configured to receive torque resulting from input torque, and the torque sensor configured to sense torque acting on the spindle torque tube; and
      an electrical circuit coupled to the spindle torque sensor and extending proximate the spindle body to a location proximate a second portion of the spindle body, the electrical circuit configured to transmit signals produced by the spindle torque sensor to the location proximate the second portion of the spindle body, the location proximate the first portion of the spindle body being on a first side of one or more of the concentric gears and the location proximate the second portion of the spindle body being on a second side of the one or more of the concentric gears.
33. The system of any one of embodiment 18-32, wherein the first drive torque is configured to generate a torque that is delivered to a chainring of a chain drive system of a bicycle, and wherein a torque that is delivered to a chainring is configured to drive the chain drive system to drive rotation of a wheel of the bicycle.
34. A drive system comprising:
   a drive gear system configured to receive a motor torque and output a first drive torque, the drive gear system comprising a gear reduction stage comprising:
      concentric gears comprising:
         a first concentric gear disposed concentric to a spindle body of a pedal drive system; and
         a second concentric gear disposed concentric to the spindle body of the pedal drive system.
35. A vehicle drive system comprising:
   a motor drive system configured to output a first drive torque, the motor drive system comprising:
      a drive motor configured to output a motor torque; and
      a drive gear system configured to receive the motor torque and output the first drive torque,
   the drive gear system comprising a gear reduction stage comprising:
      a first gear;
      a second gear; and
      an idler gearset comprising:
         a first idler gear configured to engage the first gear of the gear reduction stage and the second gear of the gear reduction stage and to transmit torque from the first gear to the second gear; and
         a second idler gear configured to engage the first gear of the gear reduction stage and the second gear of the gear reduction stage and to transmit torque from the first gear to the second gear.
      an idler gearset mount comprising:
         a first post member; and
         a second post member,
         the first idler gear disposed about the first post member,
         the second idler gear disposed about the second post member,
         and the first post member and the second post member configured to support a bearing of a gear of the drive gear system.
36. The system of embodiment 35, wherein the drive gear system further comprises a third gear fixedly coupled to the second gear and fourth gear configured to engage with third gear, and wherein the third gear comprises the bearing.
37. The system of embodiment 35 or 36, wherein the idler gearset comprises first stacked bearings disposed between the first post member and the first idler gear, and second stacked bearings disposed between the first post member and the first idler gear.
38. The system of any one of embodiments 35-37, wherein the first idler gear is formed of a polymer, the second idler gear is formed of a polymer.
39. The system of any one of embodiments 35-38, wherein the first idler gear, the second idler gear, the first gear, and the second gear are configured to operate as a constrained gear system.
40. The system of any one of embodiments 35-39, wherein the first gear comprises a motor pinon gear coupled to an output of the motor drive system.
41. The system of any one of embodiments 35-40, further comprising: a pedal drive system comprising a spindle system comprising a spindle body, wherein the second gear comprises a compound gear disposed concentric to a spindle of the pedal drive system.
42. The system of any one of embodiments 35-41, wherein the drive gear system further comprises:
concentric gears comprising:
a first concentric gear disposed concentric to a spindle body of a pedal drive system; and a second concentric gear disposed concentric to the spindle body of the pedal drive system.
43. The system of any one of embodiments 35-42, further comprising a spindle system configured to receive a pedal input torque and output a second drive torque, the system further comprising:
   a clutch system configured to regulate routing of the first drive torque and the second drive torque to generate a third output torque configured to drive a wheel of the vehicle.
44. The system of embodiment 43, the pedal drive system further comprising:
   a crankarm coupled to a spindle body of the spindle system; and
   a pedal coupled to the crankarm, wherein the pedal input torque is generated based on user engagement of the pedal.
45. The system of any one of embodiments 35-44, further comprising:
   a torque sensing system comprising:
      a spindle torque sensor coupled to a spindle torque tube of a spindle system, the spindle torque tube disposed concentric to a spindle body of the spindle system and proximate a first portion of the spindle body, the spindle torque tube configured to receive torque resulting from input torque, and the torque sensor configured to sense torque acting on the spindle torque tube; and
      an electrical circuit coupled to the spindle torque sensor and extending proximate the spindle body to a location proximate a second portion of the spindle body, the electrical circuit configured to transmit signals produced by the spindle torque sensor to the location proximate the second portion of the spindle body, the location proximate the first portion of the spindle body being on a first side of one or more gears concentric to the spindle body and the location proximate the second portion of the spindle body being on a second side of the one or more gears concentric to the spindle body.
46. The system of any one of embodiments 35-45, further comprising a bicycle wheel configured to be driven into rotation as a result of the first drive torque.
47. The system of any one of embodiments 35-46, wherein the vehicle comprises a bike.
48. The system of any one of embodiments 35-47, wherein the motor comprises a battery powered electric motor.
49. A vehicle drive system comprising:
   a drive gear system configured to receive a motor torque and output a first drive torque,
   the drive gear system comprising a gear reduction stage comprising:
      a first gear;
      a second gear; and
      an idler gearset comprising:
         a first idler gear configured to engage a first gear of the gear reduction stage and a second gear of the gear reduction stage and to transmit torque from the first gear to the second gear; and
         a second idler gear configured to engage the first gear of the gear reduction stage and the second gear of the gear reduction stage and to transmit torque from the first gear to the second gear.
50. A bicycle system comprising:
   a spindle system configured to receive a pedal input torque and output a drive torque, the spindle system comprising:
      a spindle body configured to receive the pedal input torque;
      a spindle torque tube configured to receive torque resulting from the pedal input torque and output the drive torque, the spindle torque tube disposed concentric to the spindle body of the spindle system and proximate a first portion of the spindle body; and
      a torque sensing system comprising:
         a spindle torque sensor coupled to the spindle torque tube of the spindle system, the spindle torque sensor configured to sense torque acting on the spindle torque tube; and
         an electrical circuit coupled to the spindle torque sensor and extending proximate the spindle body to a location proximate a second portion of the spindle body, the electrical circuit configured to transmit signals produced by the spindle torque sensor to the location proximate the second portion of the spindle body.
51. The system of embodiment 50, wherein the electrical circuit comprises one or more conductive paths configured to transmit electrical signals and appropriately insulated.
52. The system of embodiment 50 or 51, wherein the electrical circuit comprises a flexible ribbon cable comprising conductive paths configured to transmit electrical signals.
53. The system of any one of embodiments 50-52, wherein the spindle body comprises a recess and the electrical circuit is disposed in the recess.
54. The system of any one of embodiments 50-53, wherein the spindle torque tube comprises a pass through, and the electrical circuit is disposed in the pass through.
55. The system of any one of embodiments 50-54, the bicycle system further comprises a stator disposed proximate the second portion of the spindle body, wherein a first end of the electrical circuit is coupled to the spindle torque sensor and a second end of the electrical circuit is coupled to a rotor disposed proximate the second portion of the spindle body and configured to rotate with the spindle body and relative to the stator, and wherein the stator and rotor are communicatively coupled.
56. The system of any one of embodiments 50-55, wherein the stator and rotor are communicatively coupled by way of one or more of the following: optical coupling, inductive coupling, capacitive coupling, near-field transmission, and rotary brushes.
57. The system of any one of embodiments 50-56, wherein the spindle torque sensor comprises a strain gauge.
58. The system of any one of embodiments 50-57, further comprising:
   a pedal drive system comprising:
      the spindle system;
      a crankarm coupled to the spindle body; and
      a pedal coupled to the crankarm, wherein the pedal input torque is generated based on user engagement of the pedal.
59. The system of any one of embodiments 50-58, further comprising:
   a motor drive system configured to output a second drive torque; and
   a clutch system configured to regulate routing of the drive torque and the second drive torque to generate a third output torque configured to drive a wheel of the bicycle.
60. The system of any one of embodiments 50-59, the motor drive system comprising:
   a drive motor configured to output a motor torque; and
   a drive gear system configured to receive the motor torque and output the second drive torque.
61. The system of any one of embodiments 50-60, wherein:
   the drive gear system comprises a gear reduction stage comprising two or more concentric gears disposed concentric to the spindle body, and
   the electrical circuit passing through an interior of the two or more concentric gears.
62. The system of any one of embodiments 50-61, wherein the electrical circuit is configured to run through, around, or underneath one or more of gears concentric to the spindle.
63. The system of any one of embodiments 50-62, the location proximate the first portion of the spindle body being on a first side of one or more gears concentric to the spindle body and the location proximate the second portion of the spindle body being on a second side of the one or more gears concentric to the spindle body.
64. A vehicle system comprising:
   a torque sensing system comprising:
      a spindle torque sensor coupled to a spindle torque tube of a spindle system configured to receive a pedal input torque and output a drive torque, the spindle torque tube disposed concentric to a spindle body of the spindle system and proximate a first portion of the spindle body, the spindle torque sensor configured to sense torque acting on the spindle torque tube, the spindle system; and
      an electrical circuit coupled to the spindle torque sensor and extending proximate the spindle body to a location proximate a second portion of the spindle body, the circuit configured to transmit signals produced by the spindle torque sensor to the location proximate the second portion of the spindle body.
65. The system of embodiment 64, the location proximate the first portion of the spindle body being on a first side of one or more gears concentric to the spindle body and the location proximate the second portion of the spindle body being on a second side of the one or more gears concentric to the spindle body.

What is claimed is:

1. A motorized bicycle system comprising:
an electric drive system configured to output a first drive torque, the electric drive system comprising:
an electric drive motor configured to output a motor torque; and
a mid-drive gear box system configured to receive the motor torque and output the first drive torque;
a pedal drive system configured to output a second drive torque, the pedal drive system comprising a spindle system configured to receive a pedal input torque and output the second drive torque; and
a clutch system configured to regulate routing of the first drive torque and the second drive torque to generate a third output torque configured to be delivered to a chainring of a wheel drive system of a bicycle;
the mid-drive gear box system comprising a gear reduction stage comprising:
two or more concentric gears, each concentric gear of the two or more concentric gears is disposed concentric to a spindle body of the spindle system of the pedal drive system; and
a parallel axis idler gearset comprising:
a first idler gear configured to engage a first gear of the gear reduction stage and a second gear of the gear reduction stage and to transmit torque from the first gear to the second gear; and
a second idler gear configured to engage the first gear of the gear reduction stage and the second gear of the gear reduction stage and to transmit torque from the first gear to the second gear.

2. The system of claim 1, wherein the electric drive motor comprises a battery powered electric motor.

3. The system of claim 1, wherein the pedal drive system comprises a crankarm coupled to the spindle system and a pedal coupled to the crankarm, and wherein user engagement of the pedal is configured to generate the pedal input torque.

4. The system of claim 1, wherein the clutch system is configured to selectively engage one or both of (a) an output of the mid-drive gear box system, and (b) an output of the spindle system, to generate the third output torque.

5. The system of claim 1, wherein the two or more concentric gears further comprise a third concentric gear disposed concentric to the spindle body of the pedal drive system.

6. The system of claim 1, wherein the two or more concentric gears comprise:
a first compound gear disposed concentric to the spindle body; and
an output gear disposed concentric to the spindle body,
the first compound gear comprising a first compound gear input gear and a first compound gear output gear fixedly coupled to the first compound gear input gear, and
the output gear configured to be selectively engaged by the clutch system.

7. The system of claim 6, wherein the second gear of the gear reduction stage comprises the first compound gear.

8. The system of claim 6, wherein the gear reduction stage comprises:
a second compound gear comprising:
a second compound gear input gear; and
a second compound gear output gear,
the second compound gear input gear configured to engage the first compound gear output, and
the second compound gear output gear configured to engage the output gear.

9. The system of claim 1, wherein the gear reduction stage comprises intermediate gearing, configured to engage a first concentric gear of the two or more concentric gears and to engage a second concentric gear of the two or more concentric gears, to transfer torque from the first concentric gear to the second concentric gear.

10. The system of claim 1, wherein the spindle body is configured to rotate free of physical interaction with the two or more concentric gears of the mid-drive gear box system.

11. The system of claim 1, wherein a bearing of a compound gearset is supported by post members about which the idler gears are disposed.

12. The system of claim 1, wherein the first idler gear, the second idler gear, the first gear of the gear reduction stage, and the second gear of the gear reduction stage are configured to operate as a constrained gear system.

13. The system of claim 1, wherein the first gear of the gear reduction stage comprises a motor pinon gear coupled to an output of the electric drive system.

14. The system of claim 1, wherein the second gear of the gear reduction stage comprises a first compound gear disposed concentric to the spindle body of the spindle system of the pedal drive system.

15. The system of claim 1, further comprising:
a torque sensing circuit comprising:
a spindle torque sensor coupled to a spindle torque tube of the spindle system, the spindle torque tube disposed concentric to the spindle body of the spindle system and proximate a first portion of the spindle body, the spindle torque tube configured to receive torque resulting from the pedal input torque, and the torque sensor configured to sense torque acting on the spindle torque tube; and
an electrical circuit coupled to the spindle torque sensor and extending proximate the spindle body to a location proximate a second portion of the spindle body, the electrical circuit configured to transmit signals produced by the spindle torque sensor to the location proximate the second portion of the spindle body, the location proximate the first portion of the spindle body being on a first side of one or more of the two or more concentric gears and the location proximate the second portion of the spindle body being on a second side of the one or more of the two or more concentric gears.

16. The system of claim 1, the wheel drive system comprising a chain or belt configured to transmit the third output torque to drive a wheel of the bicycle into rotation.

17. A vehicle drive system comprising:
a motor drive system configured to output a first drive torque, the motor drive system comprising:
a drive motor configured to output a motor torque; and
a drive gear system configured to receive the motor torque and output the first drive torque; and
a pedal drive system comprising a spindle system comprising a spindle body,
the drive gear system comprising a gear reduction stage comprising:
concentric gears comprising:
a first concentric gear disposed concentric to the spindle body of the pedal drive system; and
a second concentric gear disposed concentric to the spindle body of the pedal drive system.

18. The system of claim 17, the spindle system configured to receive a pedal input torque and output a second drive torque.

19. The system of claim 17, further comprising a third concentric gear disposed concentric to the spindle body of the pedal drive system.

20. The system of claim 17, wherein the first drive torque is configured to generate a torque that is delivered to a chainring of a chain drive system of a bicycle, and wherein a torque that is delivered to a chainring is configured to drive the chain drive system to drive rotation of a wheel of the bicycle.
